(19) United States
(12) Patent Application Publication
(10) Pub. No.: US 2026/0190200 A1
(43) Pub. Date: Jul. 2, 2026

(54) PERFORMANCE INPUT DEVICE AND PERFORMANCE INPUT METHOD

(71) Applicant: Yamaha Corporation, Hamamatsu (JP)

(72) Inventor: Yuji MIURA, Hamamatsu (JP)

(21) Appl. No.: 19/551,060

(22) Filed: Feb. 26, 2026

Related U.S. Application Data
(63) Continuation of application No. PCT/JP2023/030899, filed on Aug. 28, 2023.

(51) Int. Cl. H05B 47/105; G10H 1/00; G10H 1/34

(52) U.S. Cl. CPC H05B 47/105; G10H 1/0008; G10H 1/34; G10H 2210/076; G10H 2220/031; G10H 2220/066; G10H 2220/265

(57) ABSTRACT

A performance input device includes an operation section with illumination and an operation section without illumination. The operation section with illumination is configured to be illuminable and is configured to be operated for performance. The operation section without illumination is configured to be operated for performance. In response to the operation section with illumination being operated for performance, the lighting mode of the operation section with illumination changes.

### CROSS-REFERENCE TO RELATED APPLICATIONS

This application is a continuation application of PCT International Application No. PCT/JP2023/030899 filed on August 28, 2023. The entire disclosures of PCT International Application No. PCT/JP2023/030899 are hereby incorporated herein by reference.

### BACKGROUND

### Field of the Invention

The present invention generally relates to a performance input device that is operated for performance, and a performance input method.

### Background Information

In recent years, various electronic instruments have been developed. For example, U.S. Patent No. 11,120,781 (Patent Document 1) discloses an electronic percussion instrument. In this electronic percussion instrument, a plurality of pads and a plurality of light arrays are provided on a playing face of a housing. The plurality of light arrays respectively correspond to the plurality of pads. When any of the pads is struck, an audio event occurs and a light array corresponding to the pad changes from a dark state to a bright state.

### SUMMARY

In the electronic percussion instrument of Patent Document 1, the brightness state of the light arrays changes during a performance, thereby improving the aesthetics of the electronic percussion instrument. However, it is difficult to maintain playability while improving the aesthetics of the electronic percussion instrument.

An object of the present disclosure is to provide a performance input device and a performance input method that are able to maintain playability while improving aesthetics.

A performance input device according to one aspect of the present disclosure comprises an operation section with illumination that is configured to be illuminable and that is configured to be operated for performance, and an operation section without illumination that is configured to be operated for performance. In response to the operation section with illumination being operated for performance, lighting mode of the operation section with illumination changes.

A performance input method according to another aspect of the present disclosure is executed by a computer, the performance input method comprising receiving a performance operation from an operation section with illumination of a performance input device, receiving a performance operation from an operation section without illumination of the performance input device, and changing lighting mode of the operation section with illumination in response to receiving the performance operation from the operation section with illumination.

According to the present disclosure, it is possible to maintain playability while improving the aesthetics of a performance input device.

### BRIEF DESCRIPTION OF THE DRAWINGS

FIG. 1 is a block diagram showing the configuration of a performance input device according to one embodiment of the present disclosure.

FIG. 2 is a plan view showing the configuration of a housing.

FIG. 3 is a diagram explaining one example of the arrangement of performance operators.

FIG. 4 is a diagram explaining a first example of the correspondence between operators with illumination and operators without illumination.

FIG. 5 is a diagram explaining a second example of the correspondence between operators with illumination and operators without illumination.

FIG. 6 is a diagram explaining a third example of the correspondence between operators with illumination and operators without illumination.

FIG. 7 is a block diagram showing the configuration of functional units of the performance input device.

FIG. 8 is a flowchart showing one example of a basic control process executed by the performance input device.

FIG. 9 is a flowchart showing one example of a control process in a first additional function mode.

FIG. 10 is a flowchart showing one example of a control process in a second additional function mode.

FIG. 11 is a flowchart showing one example of a control process in a third additional function mode.

FIG. 12 is a flowchart showing one example of a control process in a fourth additional function mode.

FIG. 13 is a flowchart showing one example of a control process in a fifth additional function mode.

FIG. 14 is a flowchart showing one example of a control process in a sixth additional function mode.

FIG. 15 is a plan view showing an operation section without illumination according to another embodiment.

### DETAILED DESCRIPTION OF EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### 1. Configuration of a performance input device

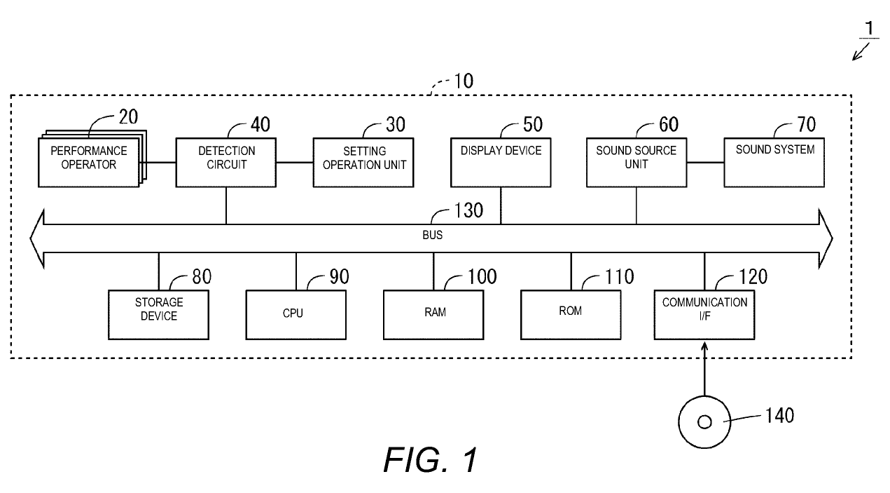

A performance input device and a performance input method according to an embodiment of the present disclosure will be described in detail below with reference to the drawings. FIG. 1 is a block diagram showing the configuration of a performance input device according to one embodiment of the present disclosure. As shown in FIG. 1, a performance input device 1 comprises a housing 10, a plurality of performance operators 20, a setting operation unit 30, a detection circuit 40, a display device 50, a sound source unit or circuit 60, a sound system 70, a storage device 80, a CPU (central processing unit) 90, RAM (random access memory) 100, ROM (read only memory) 110, a communication I/F (interface) 120, and a bus (signal bus or line) 130.

The plurality of performance operators 20, the setting operation unit 30, and the display device 50 are provided exposed from the housing 10 so as to be operable by, or visible to, the user. The detection circuit 40, the sound source unit 60, the sound system 70, the storage device 80, the CPU 90, the RAM 100, the ROM 110, the communication I/F 120, and the bus 130 are provided inside the housing 10. The detection circuit 40, the display device 50, the sound source unit 60, the storage device 80, the CPU 90, the RAM 100, the ROM 110, and the communication I/F 120 are connected to the bus 130.

The plurality of performance operators 20 and the setting operation unit 30 are connected to the detection circuit 40. In the present example, the performance input device 1 is a finger drum pad, and includes a plurality of pad operators or button-type operators as the plurality of performance operators 20. The timbres of a plurality of types of drums, cymbals, etc., are associated with the plurality of performance operators 20. In addition, the plurality of performance operators 20 include operators with illumination provided with illumination and operators without illumination not provided with illumination. The details will be described further below.

A user can carry out a performance operation by striking or depressing the desired performance operator 20 with a finger, such as a finger drumming operation. In addition, the user can release the performance operation by releasing the finger from the performance operator 20 or by changing the state of the performance operator 20 from a depressed state to a non-depressed state. A hold function is provided to the performance input device 1. When the hold function is on, each time a performance operator 20 is struck, the state switches between a state in which the performance operator 20 is operated for performance and a state in which the performance operation of the performance operator 20 is released.

The setting operation unit 30 includes a user interface that receives, from the user, setting operations for making various settings regarding the performance input device 1. The various settings include setting the correspondence between the plurality of performance operators 20 and timbre, setting the lighting mode of operators with illumination, described further below, and the like. The detection circuit 40 detects the user's performance operation on each of the performance operators 20. The detection circuit 40 includes a sensor device including at least one of a piezoelectric sensor, a pressure sensor, a capacitive sensor and a position sensor. The sensor device has a sensing portion corresponding to each of the performance operators 20 to detect the user's performance operation on each of the performance operators 20. The striking strength with which the performance operator 20 is struck (e.g., Note On Velocity) and the depressing strength with which the performance operator 20 is depressed (e.g., After Touch Value) can be determined by the CPU 90 on the basis of the detection result of the performance operation detected by the detection circuit 40. In addition, the detection circuit 40 detects the user's setting operation on the setting operation unit 30.

The display device 50 includes a liquid crystal display, for example. The display device 50 displays the title of the musical piece, a musical score, the setting contents of the performance input device 1, and the like. The display device 50 can be a touch panel display. In this case, some or all of the plurality of performance operators 20 or the setting operation unit 30 can be displayed on the display device 50. As a result, the user can carry out a performance operation or a setting operation on the display device 50.

The sound source unit or circuit 60 outputs audio data on the basis of a performance operation on the performance operator 20 detected by the detection circuit 40. The audio data are sampling data indicating sound waveforms. Hereinbelow, audio data output from the sound source unit 60 will be referred to as sound signal. The sound system 70 includes a digital-to-analog (D/A) conversion circuit, an amplifier, and a speaker, and is connected to the sound source unit 60. The sound system 70 converts a sound signal provided by the sound source unit 60 into an analog sound signal, and outputs a sound based on the analog sound signal.

The storage device 80 includes a storage medium such as a hard disk, an optical disk, a magnetic disk, or a memory card, in which computer programs such as a control program for controlling sound generation, lighting mode, etc., are stored. The storage device 80 can further store musical score data indicating a musical score, or the like. In the illustrated embodiment, the CPU 90 is illustrated as an electronic controller or processor of the performance input device 1 that executes a control program stored in the storage device 80, thereby executing a control process of the performance input device 1. The RAM 100 is composed of volatile memory, for example, and is used as a work area of the CPU 90 as well as temporarily storing various data.

The ROM 110 is composed of non-volatile memory, for example, and stores a control program. Instead of the storage device 80, the ROM 110 can store the control program. The control program can be provided in a form stored in a storage medium 140 such as a computer-readable CD (compact disc)-ROM, and be read out via the communication I/F 120, thereby being installed in the storage device 80 or the ROM 110. In addition, if the communication I/F 120 is connected to a communication network, a control program distributed from a server connected to the communication network can be installed in the storage device 80 or the ROM 110.

### 2. Configuration of performance operators

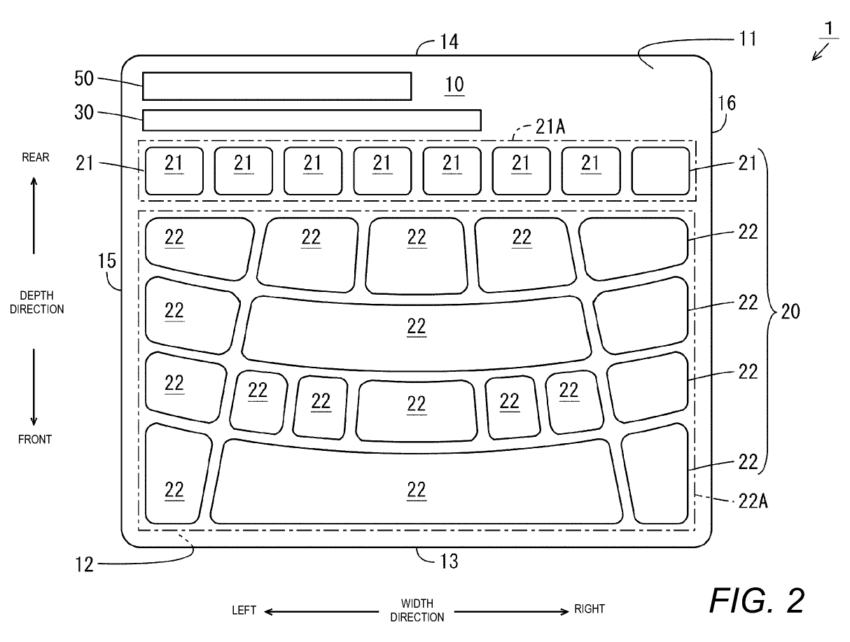

FIG. 2 is a plan view showing the configuration of the housing 10. As shown in FIG. 2, the housing 10 has an essentially rectangular parallelepiped shape composed of main faces or surfaces 11 to 16. The main face 11 and the main face 12 face each other, the main face 13 and the main face 14 face each other, and the main face 15 and the main face 16 face each other. Hereinbelow, the direction in which the main faces 11 and 12 are aligned (direction perpendicular to the drawing of FIG. 2) is referred to as the height direction. The direction in which the main faces 13 and 14 are aligned (up-down direction in FIG. 2) is referred to as the depth direction. The direction in which the main faces 15 and 16 are aligned (left-right direction in FIG. 2) is referred to as the width direction. The depth direction is an example of the first direction, and the width direction is an example of the second direction. The height direction, the depth direction, and the width direction are orthogonal to each other.

In addition, in the height direction, the direction in which the main face 11 is located is referred to as up, and the direction in which the main face 12 is located is referred to as down. In the depth direction, the direction in which the main face 13 is located is referred to as front, and the direction in which the main face 14 is located is referred to as rear. In the width direction, the direction in which the main face 15 is located is referred to as left, and the direction in which the main face 16 is located is referred to as right. The user of the performance input device 1 carries out performance operations on the performance operator 20 from the front direction while playing. Accordingly, the main face 13 of the housing 10 is one end face (e.g., an end face) facing the user when playing.

The plurality of performance operators 20 include a plurality of operators with illumination 21 and a plurality of operators without illumination 22. The plurality of operators with illumination 21 are arranged to form an operation section with illumination 21A. In addition, the plurality of operators without illumination 22 are arranged to form an operation section without illumination 22A. The operation section with illumination 21A, the operation section without illumination 22A, the setting operation unit 30, and the display device 50 are provided so as to be exposed from the main face 11 of the housing 10.

In the present embodiment, the operation section without illumination 22A is disposed in the front portion of the main face 11. The operation section with illumination 21A is disposed on the main face 11, rearward of the operation section without illumination 22A. That is, the operation section with illumination 21A and the operation section without illumination 22A are arranged along the depth direction (first direction), and the operation section with illumination 21A is disposed at a location farther from the main face 13 than the operation section without illumination 22A. The setting operation unit 30 is disposed near the left end of the main face 11, rearward of the operation section with illumination 21A. The display device 50 is disposed near the left end of the main face 11, rearward of the setting operation unit 30.

Each of the operators with illumination 21 is configured to be illuminable by including a light or lighting element. Each light can be, for example, a light-emitting diode. In addition, each of the operators with illumination 21 can include a plurality of lights that are lit in mutually different colors. When each of the operators with illumination 21 is operated for performance, the light of the operator with illumination 21 is activated and the lighting mode of each of the operators with illumination 21 changes. When the performance operation on each of the operators with illumination 21 is released, the lighting mode of the operator with illumination 21 returns to the state before the change. In particular, in the illustrated embodiment, in response to the CPU 90 detecting that the operation section with illumination 21A (i.e., the operators with illumination 21) is operated for performance, the CUP 90 changes the lighting mode of the operation section with illumination 21A (i.e., the operators with illumination 21). Similarly, in response to the CPU 90 detecting that the operation section with illumination 21A (i.e., the operators with illumination 21) is released, the CUP 90 returns the lighting mode of the operation section with illumination 21A (i.e., the operators with illumination 21) to the state before the change.

In addition, as described further below, the performance input device 1 can be operated in various selected additional function modes, or be simultaneously operated in a plurality of additional function modes. The user can operate the setting operation unit 30 to select an additional function mode of the performance input device 1. In addition, in each of the additional function modes of the performance input device 1, when a specific event occurs, the lighting mode of each of the operators with illumination 21 changes even when (while) none of the operators with illumination 21 is being operated for performance.

The lighting mode includes the color, brightness (or luminosity), blinking pattern, and blinking speed of the light. For example, changing of the lighting mode can be the light of the illumination changing from white to another color, such as red, blue, or green. In addition, changing of the lighting mode can be the light of the illumination changing from a dark state (including a turned-off state) to a bright state, or the light of the illumination changing from a bright state to a dark state.

The user can operate the setting operation unit 30 to select the desired lighting mode. In addition, the user can operate the setting operation unit 30 to select, from a plurality of levels, the brightness of the light in the bright state. The lighting mode can be set to be different for each event. In this case, the user can visually check the lighting mode to easily recognize which event occurred, even when the performance input device 1 is operated in a plurality of additional function modes.

In addition, the user can operate the setting operation unit 30 to vary the change in the lighting mode of each of the operators with illumination 21 depending on the strength with which the operator with illumination 21 is struck or depressed. Similarly, the user can operate the setting operation unit 30 to vary the change in the lighting mode of each of the operators with illumination 21 depending on whether a striking performance operation is carried out or a depressing performance operation is carried out with respect to the operator with illumination 21.

In this manner, the operation section with illumination 21A and the operation section without illumination 22A are provided on the same main face 11 of the housing 10. The operation section with illumination 21A includes a plurality of the operators with illumination 21, whereby when the operation section with illumination 21A is operated for performance, or when a specific event occurs, the lighting mode of the operation section with illumination 21A changes. It should be noted that the operators without illumination 22 do not include illumination, and each of the operators without illumination 22 does not light up. Therefore, even when the operation section without illumination 22A is operated for performance, the operation section without illumination 22A does not light up.

### 3. Arrangement of performance operators

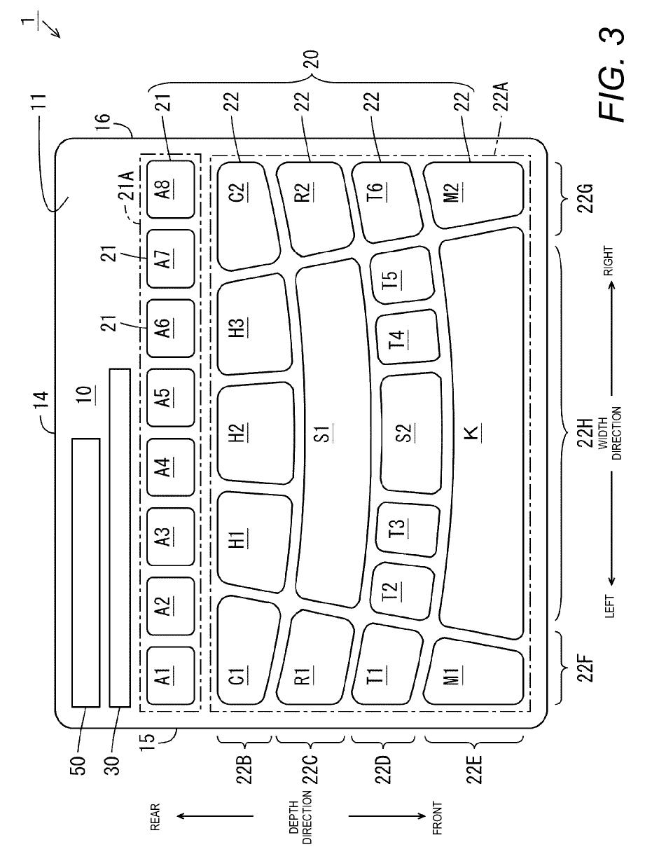

FIG. 3 is a diagram explaining one example of the arrangement of the performance operators 20. As shown in FIG. 3, the operation section with illumination 21A includes eight operators with illumination 21. When distinguishing between the eight operators with illumination 21, the eight operators with illumination 21 will be respectively referred to as operators A1 to A8. In addition, the operation section without illumination 22A includes 18 operators without illumination 22. When distinguishing between the 18 operators without illumination 22, the 18 operators without illumination 22 will be respectively referred to as C1, C2, H1 to H3, K, M1, M2, R1, R2, S1, S2, and T1 to T6.

Each of the plurality of performance operators 20 is associated with a timbre of a drum, a cymbal, or the like. For example, in the initial setting, timbres of crash cymbals are associated with operators C1 and C2, and timbres of hi-hats are associated with operators H1 to H3. In addition, timbres of ride cymbals are associated with operators R1 and R2, timbres of snare drums are associated with operators S1 and S2, and timbres of tom-toms are associated with operators T1 to T6. The user can operate the setting operation unit 30 to associate a desired timbre to each of the performance operators 20.

The plurality of operators with illumination 21 are arranged along the width direction (second direction). The plurality of operators without illumination 22 are arranged along the depth direction (first direction) and the width direction (second direction). In the present embodiment, the operators A1 to A8 are arranged linearly in this order from left to right. The operators C1, H1, H2, H3, and C2 are arranged in this order from left to right. The operators R1, S1, and R2 are arranged in this order from left to right, in front of the operators C1, H1 to H3, and C2. The operators T1, T2, T3, S2, T4, T5, and T6 are arranged in this order from left to right, in front of the operators R1, S1, and R2. The operators M1, K, and M2 are arranged in this order from left to right, in front of the operators T1 to T3, S2, and T4 to T6.

The plurality of operators with illumination 21 have the same shape (essentially rectangular shape in the present example). On the other hand, the plurality of operators without illumination 22 have mutually different shapes. Here, since it is not necessary to provide illumination for each of the operators without illumination 22, the size of each of the operators without illumination 22 can be easily increased. As a result, in the present example, the area of each of the operators without illumination 22 is set to be equal to or greater than the area of the operators with illumination 21 in plan view. According to this configuration, the user can operate each of the operators without illumination 22 for performance more easily than each of the operators with illumination 21.

In particular, the operators S1 and K have shapes that extend long in the width direction. Specifically, the operator S1 is disposed in front of the operators H1 to H3 which are aligned in the width direction. The operators T2, T3, S2, T4, and T5 aligned in the width direction are arranged in front of the operator S1. The operator K is disposed in front of the operators T2, T3, S2, T4, and T5 which are aligned in the width direction. In this manner, since the operators S1 and K are several times larger than the other operators without illumination 22, the user can more easily operate the operators S1 and K for performance.

In addition, the front end face of an operator group 22B consisting of operators C1, H1 to H3, and C2 has a curved shape in which the center portion protrudes toward the front. The rear end face of an operator group 22C consisting of operators R1, S1, and R2 has a curved shape conforming to the front end face of the operator group 22B. The front end face of the operator group 22C has a curved shape essentially parallel to the rear end face. The rear end face of an operator group 22D consisting of operators T1 to T3, S2, and T4-T6 has a curved shape conforming to the front end face of the operator group 22C. The front end face of the operator group 22D has a curved shape essentially parallel to the rear end face. The rear end face of an operator group 22E consisting of operators M1, K, and M2 has a curved shape conforming to the front end face of the operator group 22D.

Regarding the shapes of the operators without illumination 22 described above, the operators R1, S1, and R2 are arranged not linearly but curved in the width direction. Similarly, the operators T1 to T3, S2, and T4 to T6 are arranged not linearly but curved in the width direction. However, the embodiment is not limited thereto. The operators R1, S1, and R2 can be arranged linearly in the width direction, and the operators T1 to T3, S2, and T4 to T6 can be arranged linearly in the width direction.

Each of the operators without illumination 22 is associated with one of the operators with illumination 21. The correspondence between the operators without illumination 22 and the operators with illumination 21 does not need to be one-to-one. Accordingly, the correspondence between the operators without illumination 22 and the operators with illumination 21 can be many-to-one or one-to-many. Each of the operators without illumination 22 can be associated with the operator with illumination 21 closest to the operator without illumination 22. In other words, each of the operators without illumination 22 can be associated with the operator 21 overlapping with the operator without illumination 22 in the depth direction. In the illustrated embodiment, each of the operators with illumination 21 is associated with one (or at least one) of the operators without illumination 22. However, the present disclosure is not limited to this configuration, and at least one of the operators with illumination 21 can be associated with at least one of the operators without illumination 22.

In the arrangement of the performance operators 20 in the present example, an operator group 22F consisting of operators C1, R1, T1, and M1 are located in front of the operator A1 at the left end of the main face 11. An operator group 22G consisting of operators C2, R2, T6, and M2 are located in front of the operator A8 at the right end of the main face 11. Accordingly, the operators C1, R1, T1, and M1 overlap with the operator A1 in the depth direction. The operators C2, R2, T6, and M2 overlap with the operator A8 in the depth direction.

In addition, an operator group 22H consisting of operators H1 to H3, K, S1, S2, and T2 to T5 is located between the operator group 22F and the operator group 22G, and in front of the operators A2 to A7 on the main face 11. Specifically, the operator T2 overlaps with the operator A2 in the depth direction. The operators H1 and T3 overlap with the operator A3 in the depth direction. The operators H2 and S2 overlap with the operators A4 and A5 in the depth direction. The operators H3 and T4 overlap with the operator A6 in the depth direction. The operator T5 overlaps with the operator A7 in the depth direction. In addition, as described above, since the operators S1 and K extend long in the width direction, the operators S1 and K overlap with the operators A2-A7 in the depth direction.

Each of the operators without illumination 22 can overlap in the depth direction with an operator with illumination 21 other than the operators with illumination 21 described above. In the present example, the right end face of the operator group 22F gradually inclines toward the left, from the rear to the front. The left end face of the operator group 22G gradually inclines toward the right, from the rear to the front. The left end face of the operator group 22H gradually inclines toward the left, from the rear to the front, so as to conform to the right end face of the operator group 22F. The right end face of the operator group 22H gradually inclines toward the right, from the rear to the front, so as to conform to the left end face of the operator group 22G. Therefore, the operators C1, R1, and T1 also overlap with the operator A2 in the depth direction. The operators C2, R2, and T6 also overlap with the operator A7 in the depth direction.

### 4. Additional function modes

### (1) First additional function mode

As described above, each of the operators with illumination 21 is associated with one of the operators without illumination 22. In the first additional function mode, even when the operators with illumination 21 are not being operated for performance, when one of the operators without illumination 22 is operated for performance, the lighting mode of the corresponding operator with illumination 21 changes. When the performance operation on each of the operators with illumination 22 is released, the lighting mode of the corresponding operator with illumination 21 returns to the state before the change. Accordingly, in the first additional function mode, the lighting mode of each of the operators with illumination 21 changes, not only when the operator with illumination 21 is operated for performance, but also when the corresponding operator without illumination 22 is operated for performance. In particular, in the illustrated embodiment, the CPU 90 changes the lighting mode of each of the operators with illumination 21 in response to the CPU 90 detecting that the operator with illumination 21 is operated for performance, or in response to the CPU 90 detecting the corresponding operator without illumination 22 associated with the operator with illumination 21 is operated for performance.

The user can operate the setting operation unit 30 to vary the lighting mode of each of the operators with illumination 21 for each of the corresponding operator without illumination 22. In addition, the user can operate the setting operation unit 30 to vary the change in the lighting mode of each of the operators with illumination 21 depending on the strength with which the corresponding operator without illumination 22 is struck or depressed. Similarly, the user can operate the setting operation unit 30 to vary the change in the lighting mode of each of the operators with illumination 21 depending on whether a striking performance operation is carried out or a depressing performance operation is carried out with respect to the corresponding operator without illumination 22.

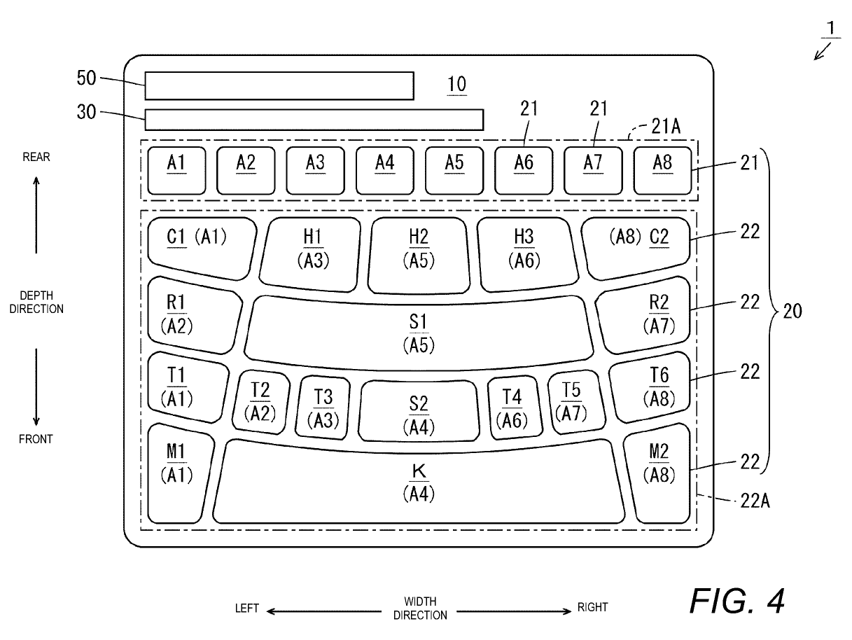

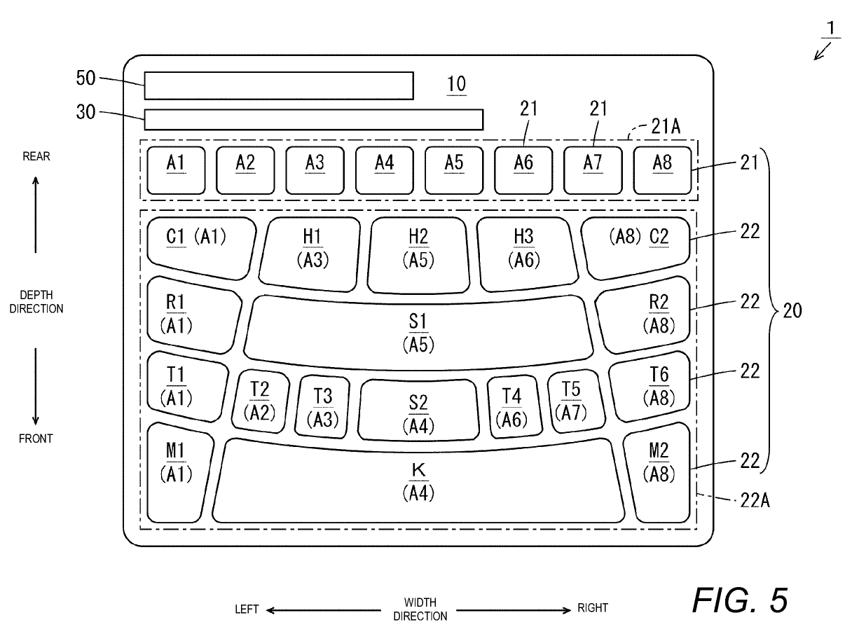

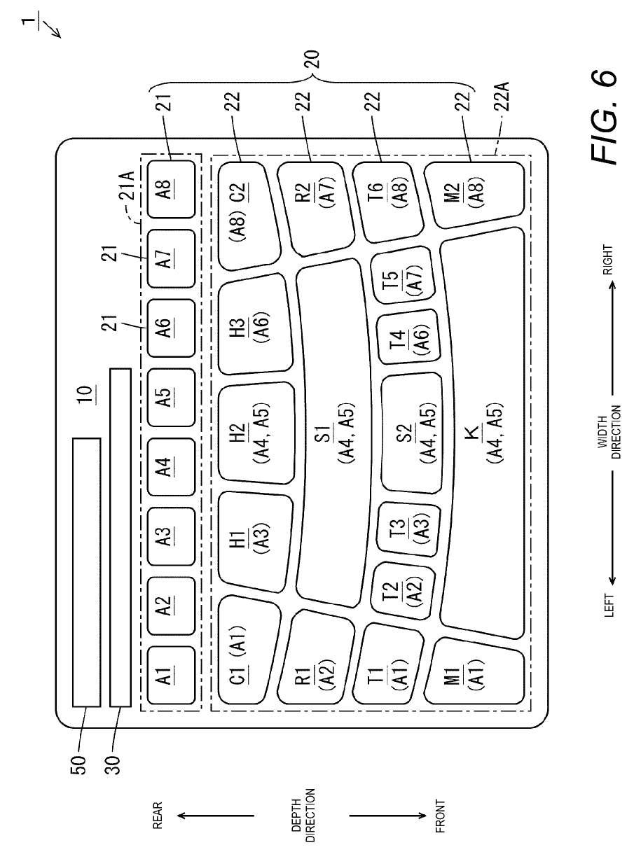

FIG. 4 is a diagram explaining a first example of the correspondence between the operators with illumination 21 and the operators without illumination 22. In FIG. 4, near the reference symbol of each of the operators without illumination 22, the reference symbol of the corresponding operator with illumination 21 is indicated within parentheses. The same applies to FIGS. 5 and 6, described further below.

As shown in FIG. 4, in the present example, the operator A1 is associated with the operators C1, T1, and M1. The operator A2 is associated with the operators R1 and T2. The operator A3 is associated with the operators H1 and H3. The operator A4 is associated with the operators S2 and K. The operator A5 is associated with the operators H2 and S1. The operator A6 is associated with the operators H3 and T4. The operator A7 is associated with the operators R2 and T5. The operator A8 is associated with the operators C2, T6, and M2.

In this manner, in the present example, each of the operators without illumination 22 is associated with an operator with illumination 21 that is relatively proximate to the operator without illumination 22 in the depth direction. As a result, the user can instinctively recognize the correspondence between the operators with illumination 21 and the operators without illumination 22. In addition, since the number of the operators without illumination 22 that are associated with each of the operators with illumination 21 is approximately equal (two or three in the present example), changes in the lighting mode of the plurality of operators with illumination 21 when the operators without illumination 22 are operated for performance can be brought close to equal.

As described above, it is possible to set the lighting mode of each of the operators with illumination 21 to vary for each of the corresponding operator without illumination 22. As a result of such a setting being made, the user can easily distinguish which of the operators without illumination 22 was operated for performance even when the lighting mode of the same operator with illumination 21 changes.

FIG. 5 is a diagram explaining a second example of the correspondence between the operators with illumination 21 and the operators without illumination 22. As shown in FIG. 5, the present example has the same correspondence as in the first example, except that the operator R1 is associated not with the operator A2 but with the operator A1, and that the operator R2 is associated not with the operator A7 but with the operator A8. In the present example, each of the operators without illumination 22 is associated with an operator with illumination 21 that is closest to the operator without illumination 22 in the depth direction. In this case, the user can more instinctively recognize the correspondence between the operators with illumination 21 and the operators without illumination 22.

FIG. 6 is a diagram explaining a third example of the correspondence between the operators with illumination 21 and the operators without illumination 22. As shown in FIG. 6, the present example has the same correspondence as in the first example, except that the operators H2 and S1 are associated not only with the operator A5 but also with the operator A4, and that the operators K and S2 are associated not only with the operator A4 but also with the operator A5. In the present example, the operators without illumination 22 arranged in the center in the width direction are associated with the operators with illumination 21 arranged in the center in the width direction. In this case, the user can more instinctively recognize the correspondence between some of the operators with illumination 21 and the operators without illumination 22.

In the first additional function mode, when one of the operators without illumination 22 is operated for performance, the lighting mode of not only the corresponding operator with illumination 21 but also of the other operators with illumination 21 can change. Hereinbelow, of the operators with illumination 21 whose lighting mode changes, the corresponding operator with illumination 21 is referred to as main operator with illumination 21, and the other operators with illumination 21 are referred to as sub operators with illumination 21. The sub operators with illumination 21 can be operators with illumination 21 adjacent to the main operator with illumination 21.

In addition, the lighting mode of the main operator with illumination 21 can be different from the lighting mode of the sub operators with illumination 21. For example, when one of the operators without illumination 22 is operated for performance, the main operator with illumination 21 can be lit up in a different color from the sub operators with illumination 21, or can be lit up with a greater brightness than the sub operators with illumination 21. The user can operate the setting operation unit 30 to select the lighting mode of the main operator with illumination 21 and of each of the sub operators with illumination 21.

Here, there are cases in which the performance period of an operator with illumination 21 overlaps with the performance period of the operator without illumination 22 corresponding to the operator with illumination 21 (including cases in which the hold function is on). Alternatively, there are cases in which the performance periods of two or more of the operators without illumination 22 corresponding to the same operator with illumination 21 overlap. In such cases, the change in the lighting mode corresponding to the earlier performance operation on the operator with illumination 21 can be overwritten by the change in the lighting mode corresponding to the later performance operation. Alternatively, the change in the lighting mode corresponding to the earlier performance operation on the operator with illumination 21 can be combined with the change in the lighting mode corresponding to the later performance operation.

For example, when the earlier performance operation and the later performance operation are of the same type (a striking performance operation or a depressing performance operation), the change in the lighting mode corresponding to the earlier performance operation on the operator with illumination 21 can be overwritten by the change in the lighting mode corresponding to the later performance operation. On the other hand, when the earlier performance operation and the later performance operation are of different types, the change in the lighting mode corresponding to the earlier performance operation on the operator with illumination 21 can be combined with the change in the lighting mode corresponding to the later performance operation. Changes in the lighting mode that can be combined include the color and brightness of the light, for example.

### (2) Second additional function mode

In the second additional function mode, the lighting mode of the operation section with illumination 21A changes at a prescribed tempo, even when the operators with illumination 21 are not being operated for performance. The tempo can be set by the user. The user can operate the setting operation unit 30 to select the tempo. Alternatively, when musical score data indicating musical scores are stored in the storage device 80 of FIG. 1, or the like, the tempo can be specified by the musical score data.

In the present example, the operators A1 and A5 are lit up and the other operators with illumination 21 are turned off on the first beat. The operators A2 and A6 are lit up and the other operators with illumination 21 are turned off on the second beat. The operators A3 and A7 are lit up and the other operators with illumination 21 are turned off on the third beat. The operators A4 and A8 are lit up and the other operators with illumination 21 are turned off on the fourth beat. Thereafter, the same lighting modes are repeated.

### (3) Third additional function mode

In the third additional function mode, the lighting mode of the operation section with illumination 21A changes every prescribed number of bars, even when the operators with illumination 21 are not being operated for performance. The user can operate the setting operation unit 30 to select the number of bars. In the present example, the number of bars can be selected from a range of 1 bar to 127 bars. The tempo can be set by the user in the same manner as in the second additional function mode, or can be specified by the musical score data.

Specifically, N patterns of change in the lighting mode are prepared in advance. N is an integer greater than or equal to two, and is eight in the present example. Each pattern of change is provided with a unique identification number from 1 to N. The number of bars is measured on the basis of the tempo, and each time the selected number of bars has advanced, the pattern of change of the lighting mode changes to the pattern of change of the lighting mode having an identification number that is greater by one. In addition, in the present example, even when the measurement of the number of bars is reset due to a click to start playback, or the like, the pattern of change of the lighting mode changes to the pattern of change of the lighting mode having an identification number that is greater by one. After the process has proceeded until the identification number reaches N, the identification number returns to one.

Here, if the time from when the pattern of change of the lighting mode changes to when a condition for the next change in the pattern of change is satisfied is less than a prescribed period of time (for example 250 milliseconds), it is not necessary to change the pattern of change of the lighting mode. That is, the pattern of change of the lighting mode does not need to be changed at an interval that is less than a prescribed period of time. In this case, it is possible to prevent deterioration of the performance of the performance input device 1 due to frequent changes in the pattern of change of the lighting mode.

In the present embodiment, the pattern of change of the lighting mode changes so that the identification number increases sequentially, but the embodiment is not limited thereto. The pattern of change of the lighting mode can change so that the identification number decreases sequentially. Alternatively, the pattern of change of the lighting mode can change in a random order. In addition, the user can operate the setting operation unit 30 to freely specify the order of the pattern of change of the lighting mode.

### (4) Fourth additional function mode

In the fourth additional function mode, even when the operators with illumination 21 are not being operated for performance, the lighting mode of the operation section with illumination 21A changes when the timing of a beat change coincides with the timing of a performance operation on the performance operators 20. The tempo can be set by the user in the same manner as in the second additional function mode, or can be specified by the musical score data.

### (5) Fifth additional function mode

In the fifth additional function mode, even when the operators with illumination 21 are not being operated for performance, the lighting mode of the operator with illumination 21 corresponding to the performance operator 20 to be operated for performance next changes before the performance operator 20 is operated for performance. Specifically, the operator with illumination 21 or the operator without illumination 22 that should be operated for performance next, and the point in time at which the performance operation should be carried out, are identified on the basis of the musical score data acquired from the storage device 80 of FIG. 1, or the like. The lighting mode of the identified operator with illumination 21, or of the operator with illumination 21 corresponding to the identified operator without illumination 22 changes at a point in time before the performance operation should be carried out (for example, a point in time of several beats prior).

That is, in the fifth additional function mode, the operation section with illumination 21A functions as a guide that presents the performance operator 20 that should be operated for performance next. Accordingly, the user can visually check the lighting mode of the operation section with illumination 21A to appropriately practice playing the musical piece indicated by the musical score data.

### (6) Sixth additional function mode

The performance input device 1 transitions to a sleep state when the performance operators 20, the setting operation unit 30, or the like are not operated for a set period of time. The user can operate the setting operation unit 30 to select the time until the performance input device 1 transitions to the sleep state from, for example, 30 seconds, 1 minute, 2 minutes, 5 minutes, 10 minutes, 15 minutes, 30 minutes, 60 minutes, and 120 minutes. When in the sleep state, power supply to prescribed constituent elements of the performance input device 1 is stopped or reduced, thereby reducing power consumption.

In the sixth additional function mode, when the performance input device 1 is in the sleep state, the lighting mode of the operation section with illumination 21A changes in a prescribed pattern. The user can operate the setting operation unit 30 to select the pattern of change of the lighting mode of the operation section with illumination 21A in the sleep state. Accordingly, the user can visually check the lighting mode of the operation section with illumination 21A to easily check whether the performance input device 1 is in the sleep state.

### 5. Functional units of the performance input device

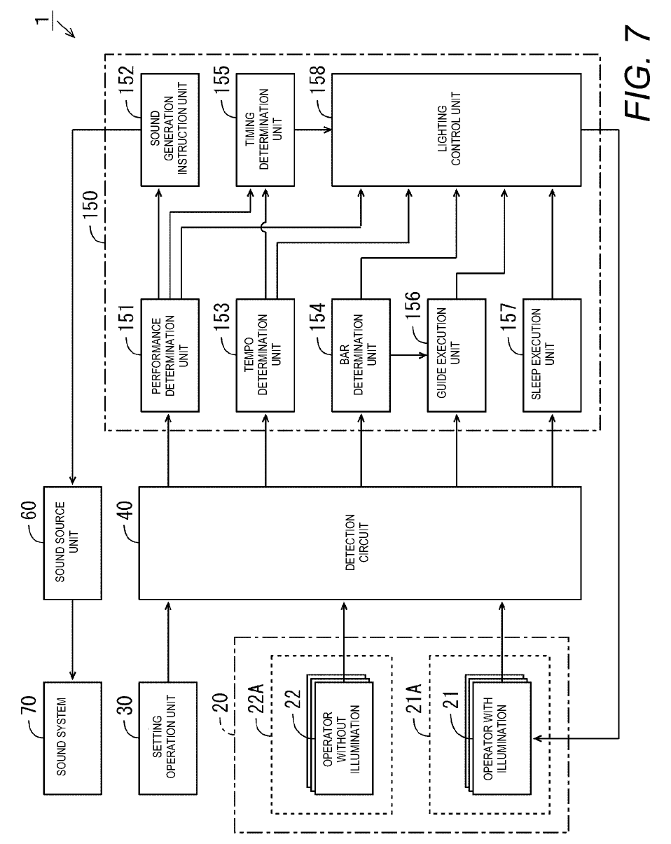

FIG. 7 is a block diagram showing the configuration of the functional units of the performance input device 1. As shown in FIG. 7, the performance input device 1 includes, as functional units 150, a performance determination unit 151, a sound generation instruction unit 152, a tempo determination unit 153, a bar determination unit 154, a timing determination unit 155, a guide execution unit 156, a sleep execution unit 157, and a lighting control unit 158. In the illustrated embodiment, the CPU 90 of FIG. 1 is illustrated as an electronic controller or processor that executes a control program stored in the storage device 80 or the like, thereby realizing the functional units 150 of the performance input device 1. Thus, the CPU 90 (i.e., the electronic controller or processor) serves as the performance determination unit 151, the sound generation instruction unit 152, the tempo determination unit 153, the bar determination unit 154, the timing determination unit 155, the guide execution unit 156, the sleep execution unit 157, and the lighting control unit 158, in a manner described below. However, at least some of the functional units 150 of the performance input device 1 can also be realized in hardware, such as an electronic circuit.

The performance determination unit 151 determines whether one of the performance operators 20 has been operated for performance on the basis of a detection result from the detection circuit 40. In addition, when one of the performance operators 20 is operated for performance, the performance determination unit 151 determines the type of the performance operation, such as a striking performance operation or a depressing performance operation. Furthermore, when a striking performance operation is carried out, the performance determination unit 151 determines the striking strength (e.g., Note on Velocity). Similarly, when a depressing performance operation is carried out, the performance determination unit 151 determines the depressing strength (e.g., After Touch Value). For example, the performance determination unit 151 can determine the striking strength (e.g., Note on Velocity) based on a detection result of a piezoelectric sensor, or a position sensor, while the performance determination unit 151 can determine the depressing strength (e.g., After Touch Value) based on a detection result of a pressure sensor or a position sensor.

The sound generation instruction unit 152 outputs a sound generation instruction signal in response to the performance operators 20 being operated for performance. The sound generation instruction signal is a signal for instructing the generation of sound (generation of a sound signal) corresponding to the performance operator 20 that is operated for performance, and the signal is provided to the sound source unit 60. When a sound generation instruction signal is provided, the sound source unit 60 outputs, to the sound system 70, a sound signal indicated by the sound generation instruction signal. As a result, a sound corresponding to the performance operation on the performance operator 20 is output from the sound system 70.

The tempo determination unit 153, the bar determination unit 154, the timing determination unit 155, and the guide execution unit 156 each have a timekeeping function. The tempo determination unit 153 acquires the tempo on the basis of a setting in the setting operation unit 30 and determines the point in time at which the beat changes. The tempo determination unit 153 can acquire the tempo on the basis of musical score data stored in the storage device 80 of FIG. 1, or the like. The bar determination unit 154 determines the point in time at which the bar has advanced by a number set in the setting operation unit 30, on the basis of the musical score data stored in the storage device 80, or the like.

The timing determination unit 155 determines whether the timing of the performance operation on the performance operator 20 determined by the performance determination unit 151 coincides with the timing of a beat change acquired by the tempo determination unit 153. The guide execution unit 156 identifies the performance operator 20 that should be operated for performance next, on the basis of the musical score data acquired by the bar determination unit 154. In addition, the guide execution unit 156 identifies the point in time at which the performance operator 20 should be operated for performance next.

The sleep execution unit 157 determines whether a period of time set in the setting operation unit 30 has elapsed since the point in time at which the detection circuit 40 ceased to detect a performance operation or a setting operation. If the period of time has elapsed, the sleep execution unit 157 causes the performance input device 1 to transition to the sleep state. Furthermore, when the detection circuit 40 detects a performance operation or a setting operation, the sleep execution unit 157 cancels the sleep state of the performance input device 1. The lighting control unit 158 controls the lighting mode of each of the operators with illumination 21 in response to an operation of the performance determination unit 151, the tempo determination unit 153, the bar determination unit 154, the timing determination unit 155, the guide execution unit 156, or the sleep execution unit 157.

### 6. Control process

### (1) Basic control process

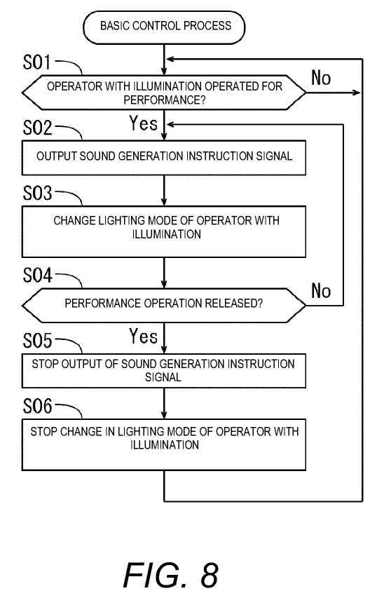

FIG. 8 is a flowchart showing one example of a basic control process executed by the performance input device 1. The performance input device 1 executes the control process of FIG. 8 for each of the operators with illumination 21 of the operation section with illumination 21A. First, the performance determination unit 151 determines whether the operators with illumination 21 have been operated for performance (step S01). If the operators with illumination 21 have been operated for performance, the type of the performance operation, the strength of striking or depressing, and the like, are also determined. If the operators with illumination 21 have not been operated for performance, the performance determination unit 151 waits until the operators with illumination 21 are operated for performance.

When the operators with illumination 21 are operated for performance, the sound generation instruction unit 152 outputs a sound generation instruction signal corresponding to the operator with illumination 21 that has been operated for performance (step S02). In addition, the lighting control unit 158 changes the lighting mode of the operator with illumination 21 that has been operated for performance (step S03). Steps S02 and S03 can be executed in any order, or be executed simultaneously. The change in the lighting mode in step S03 differs depending on the strength with which the operator with illumination 21 is struck or depressed.

Next, the performance determination unit 151 determines whether the performance operation of the operator with illumination 21 has been released (step S04). If the performance operation has not been released, the process returns to step S02. If the performance operation has been released, the sound generation instruction unit 152 stops the output of the sound generation instruction signal (step S05). In addition, the lighting control unit 158 stops the change in the lighting mode of the operator with illumination 21 (step S06). As a result, the lighting mode of the operator with illumination 21 returns to the state before the change. Steps S05 and S06 can be executed in any order, or be executed simultaneously. Thereafter, the process returns to step S01.

### (2) First additional function mode

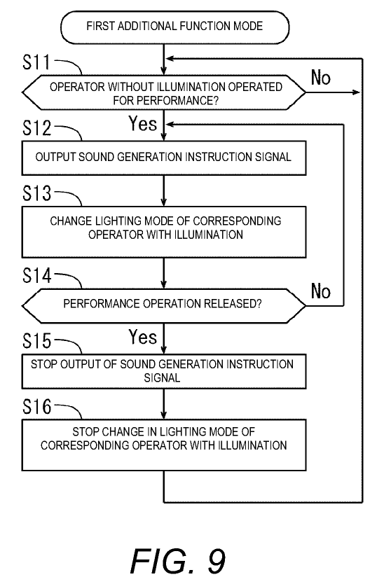

FIG. 9 is a flowchart showing one example of a control process in the first additional function mode. When the first additional function mode is in the ON state, the performance input device 1 further executes the control process of FIG. 9 for each of the operators without illumination 22 of the operation section without illumination 22A. In addition, even when the first additional function mode is in the OFF state, the performance input device 1 further executes the same control process as that shown in FIG. 9, except that execution of steps S13 and S16 of FIG. 9 is omitted.

First, the performance determination unit 151 determines whether the operators without illumination 22 have been operated for performance (step S11). If the operators without illumination 22 have been operated for performance, the type of the performance operation, the strength of striking or depressing, and the like, are also determined. If the operators without illumination 22 have not been operated for performance, the performance determination unit 151 waits until the operators without illumination 22 are operated for performance.

When the operators without illumination 22 are operated for performance, the sound generation instruction unit 152 outputs a sound generation instruction signal corresponding to the operator without illumination 22 that has been operated for performance (step S12). In addition, the lighting control unit 158 changes the lighting mode of the operator with illumination 21 corresponding to the operator without illumination 22 that has been operated for performance (step S13). Steps S12 and S13 can be executed in any order, or be executed simultaneously.

The change in the lighting mode in step S13 differs depending on the strength with which the operator without illumination 22 is struck or depressed. In addition, during a period in which an operator without illumination 22 is operated for performance, if the above-mentioned operator without illumination 22 is operated for performance, the change in the lighting mode in step S13 varies depending on the order and the type of the performance operation. Similarly, during a period in which an operator with illumination 21 is operated for performance, if another operator without illumination 22 corresponding to the above-mentioned operator with illumination 21 is operated for performance, the change in the lighting mode in step S13 varies depending on the order and the type of the performance operation.

Next, the performance determination unit 151 determines whether the performance operation of the operator without illumination 22 has been released (step S14). If the performance operation has not been released, the process returns to step S12. If the performance operation has been released, the sound generation instruction unit 152 stops the output of the sound generation instruction signal (step S15). In addition, the lighting control unit 158 stops the change in the lighting mode of the operator without illumination 22 (step S16). Steps S15 and S16 can be executed in any order, or be executed simultaneously. Thereafter, the process returns to step S11.

### (3) Second additional function mode

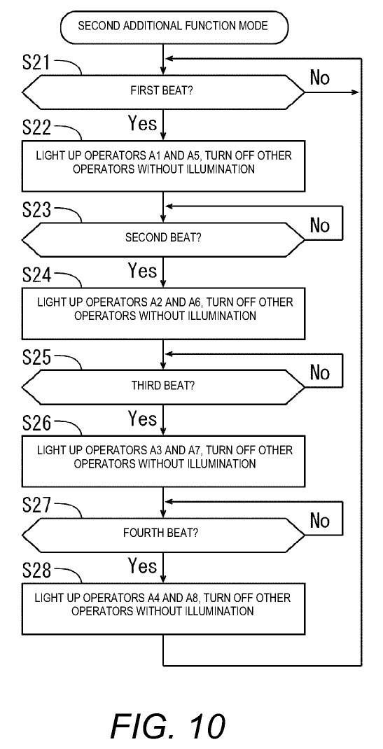

FIG. 10 is a flowchart showing one example of a control process in the second additional function mode. When the second additional function mode is in the ON state, the performance input device 1 further executes the control process of FIG. 10. First, the tempo determination unit 153 determines whether the current point in time is the first beat (step S21). If the current point in time is not the first beat, the process waits until the current point in time is the first beat. If the current point in time is the first beat, the lighting control unit 158 lights up the operators A1 and A5, and turns the other operators with illumination 21 off (step S22).

Next, the tempo determination unit 153 determines whether the current point in time is the second beat (step S23). If the current point in time is not the second beat, the process waits until the current point in time is the second beat. If the current point in time is the second beat, the lighting control unit 158 lights up the operators A2 and A6, and turns the other operators with illumination 21 off (step S24).

Subsequently, the tempo determination unit 153 determines whether the current point in time is the third beat (step S25). If the current point in time is not the third beat, the process waits until the current point in time is the third beat. If the current point in time is the third beat, the lighting control unit 158 lights up the operators A3 and A7, and turns the other operators with illumination 21 off (step S26).

Thereafter, the tempo determination unit 153 determines whether the current point in time is the fourth beat (step S27). If the current point in time is not the fourth beat, the process waits until the current point in time is the fourth beat. If the current point in time is the fourth beat, the lighting control unit 158 lights up the operators A4 and A8, and turns the other operators with illumination 21 off (step S28). Thereafter, the process returns to step S21.

### (4) Third additional function mode

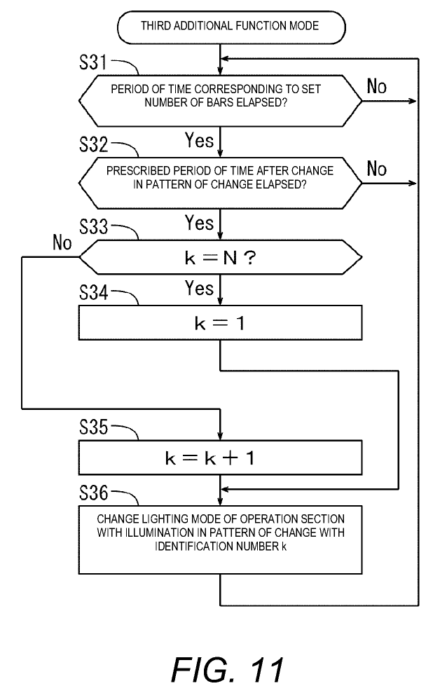

FIG. 11 is a flowchart showing one example of a control process in the third additional function mode. When the third additional function mode is in the ON state, the performance input device 1 further executes the control process of FIG. 11. First, the bar determination unit 154 determines whether a period of time corresponding to a set number of bars has elapsed (step S31). If a period of time corresponding to the number of bars has not elapsed, the process returns to step S31. If a period of time corresponding to the number of bars has elapsed, the process proceeds to step S32.

In the present example, even if a period of time corresponding to the number of bars has not elapsed in step S31, if the measurement of the number of bars is reset due to a click to start playback, or the like, the process proceeds to step S32 without returning to step S31. In step S32, the lighting control unit 158 determines whether a prescribed period of time has elapsed after a change in the pattern of change (step S32). If the prescribed period of time has not elapsed, the process returns to step S31.

If the prescribed period of time has elapsed, the lighting control unit 158 determines whether k is equal to N (step S33). k is an integer greater than or equal to 1 and less than or equal to N. The initial value of k can be 1, a value selected by the user, or the value of k when the control process was previously completed. If k is equal to N, the lighting control unit 158 sets k to 1 (step S34) and proceeds to step S36. If k is not equal to N, the lighting control unit 158 increases k by 1 (step S35) and proceeds to step S36.

In step S36, the lighting control unit 158 changes the lighting mode of the operation section with illumination 21A in the pattern of change having the identification number k (step S36). Thereafter, the process returns to step S31. As a result, each time the bar advances by the selected number of bars, the pattern of change of the lighting mode changes to the pattern of change of the lighting mode having an identification number that is greater by one. After the process has proceeded until the identification number reaches N, the identification number returns to one.

### (5) Fourth additional function mode

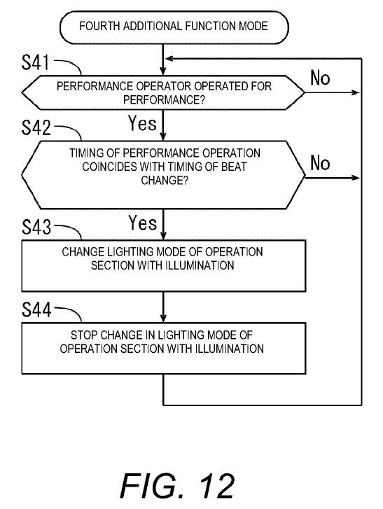

FIG. 12 is a flowchart showing one example of a control process in the fourth additional function mode. When the fourth additional function mode is in the ON state, the performance input device 1 further executes the control process of FIG. 12. First, the performance determination unit 151 determines whether any of the performance operators 20 has been operated for performance (step S41). If none of the performance operators 20 is being operated for performance, the performance determination unit 151 waits until one of the performance operators 20 is operated for performance.

When one of the performance operators 20 is operated for performance, the timing determination unit 155 determines whether the timing of the performance operation coincides with the timing of a beat change (step S42). If the timings do not coincide, the process returns to step S41. If the timings coincide, the lighting control unit 158 changes the lighting mode of the operation section with illumination 21A (step S43). Thereafter, the lighting control unit 158 stops the change in the lighting mode of the operation section with illumination 21A (step S44) and returns to step S41.

### (6) Fifth additional function mode

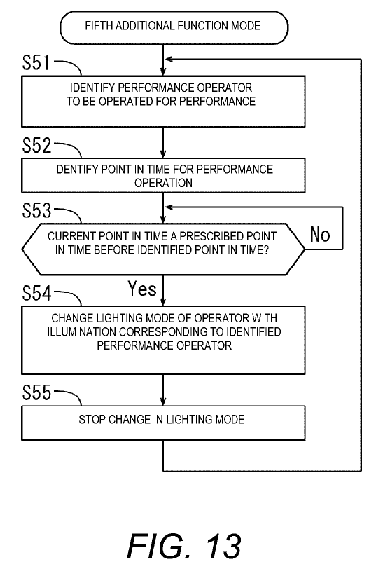

FIG. 13 is a flowchart showing one example of a control process in the fifth additional function mode. When the fifth additional function mode is in the ON state, the performance input device 1 further executes the control process of FIG. 13. First, the guide execution unit 156 identifies the performance operator 20 that should be operated for performance next, on the basis of musical score data (step S51). In step S51, a plurality of the performance operators 20 that should be operated for performance next can be identified simultaneously.

In addition, the guide execution unit 156 identifies the point in time at which a performance operation should be carried out next on the basis of the musical score data (step S52). Steps S51 and S52 can be executed in any order, or be executed simultaneously. Next, the lighting control unit 158 determines whether the current point in time is a prescribed point in time before the point in time identified in step S52 (step S53). If the current point in time is not the prescribed point in time, the lighting control unit 158 waits until the current point in time becomes the prescribed point in time.

If the current point in time is the prescribed point in time, the lighting control unit 158 changes the lighting mode of the operator with illumination 21 corresponding to the performance operator 20 identified in step S51 (step S54). Specifically, if the performance operator 20 identified in step S51 is an operator with illumination 21, the lighting mode of the operator with illumination 21 changes. On the other hand, if the performance operator 20 identified in step S51 is an operator without illumination 22, the lighting mode of the operator with illumination 21 corresponding to the operator without illumination 22 changes. As a result, the user can easily recognize the performance operator 20 that should be operated for performance next before the point in time at which the performance operation should be carried out. Thereafter, the lighting control unit 158 stops the change in the lighting mode in step S54 (step S55) and returns to step S51.

### (7) Sixth additional function mode

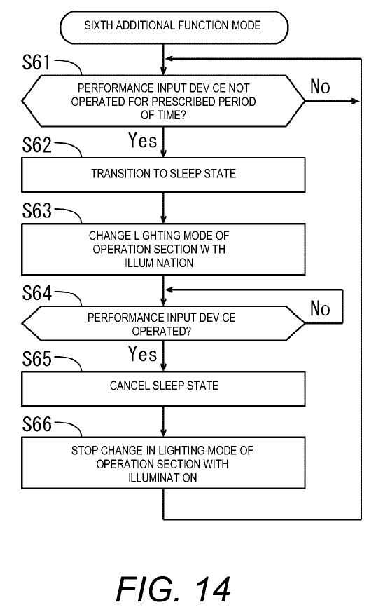

FIG. 14 is a flowchart showing one example of a control process in the sixth additional function mode. When the sixth additional function mode is in the ON state, the performance input device 1 further executes the control process of FIG. 14. First, the sleep execution unit 157 determines whether the performance input device 1 has not been operated for a prescribed period of time, on the basis of a detection result from the detection circuit 40 (step S61). If the performance input device 1 has not been operated for a prescribed period of time, the sleep execution unit 157 waits until the performance input device 1 has not been operated for the prescribed period of time.

If the performance input device 1 has not been operated for the prescribed period of time, the sleep execution unit 157 causes the performance input device 1 to transition to the sleep state (step S62). In addition, the lighting control unit 158 changes the lighting mode of the operation section with illumination 21A in a prescribed pattern (step S63). Accordingly, the user can visually check changes in the lighting mode of the operation section with illumination 21A to easily confirm that the performance input device 1 is in the sleep state. Steps S62 and S63 can be executed in any order, or be executed simultaneously.

Next, the sleep execution unit 157 determines whether the performance input device 1 has been operated, on the basis of a detection result from the detection circuit 40 (step S64). If the performance input device 1 is not operated, the sleep execution unit 157 waits until the performance input device 1 is operated. If the performance input device 1 is operated, the sleep execution unit 157 cancels the sleep state of the performance input device 1 (step S65). In addition, the lighting control unit 158 stops the change in the lighting mode of the operation section with illumination 21A (step S66) and returns to step S61. Steps S65 and S66 can be executed in any order, or be executed simultaneously.

### 7. Effects

As described above, the performance input device 1 according to the present embodiment comprises the operation section with illumination 21A that is configured to be illuminable and that is operated for performance, and the operation section without illumination 22A that is operated for performance, wherein, when the operation section with illumination 21A is operated for performance, the lighting mode of the operation section with illumination 21A changes.

According to this configuration, when the operation section with illumination 21A is operated for performance, the lighting mode changes, thereby improving the aesthetics of the performance input device 1. In addition, since lighting is not provided in the operation section without illumination 22A, the operational feel of the operation section without illumination 22A is not diminished, thus maintaining playability. As a result of the operation section with illumination 21A and the operation section without illumination 22A being appropriately provided, it is possible to maintain playability while improving the aesthetics of the performance input device 1.

The operation section with illumination 21A includes a plurality of the operators with illumination 21, the operation section without illumination 22A includes a plurality of the operators without illumination 22, each of the plurality of operators with illumination 21 is associated with one of the plurality of operators without illumination 22, and the lighting mode of each of the plurality of operators with illumination 21 can change when the operator with illumination 21 is operated for performance, or when the operator without illumination 22 associated with the operator with illumination 21 is operated for performance.

In this configuration, the lighting mode of the operation section with illumination 21A changes even when the operation section without illumination 22A is operated for performance. As a result, the user can visually recognize that the operation section without illumination 22A has been operated without diminishing the operational feel of the operation section without illumination 22A. It is thereby possible to further improve playability.

The operation section with illumination 21A and the operation section without illumination 22A are arranged along the depth direction, the plurality of operators with illumination 21 are arranged along the width direction intersecting the depth direction, the plurality of operators without illumination 22 are arranged along the width direction, and each of the plurality of operators with illumination 21 can be associated with the operators without illumination 22 that overlap in the depth direction. In this case, the operator with illumination 21 is associated with the operator without illumination 22 that is adjacent in the depth direction. As a result, the user can instinctively recognize the correspondence between the operators with illumination 21 and the operators without illumination 22.

The lighting mode of each of the plurality of operators with illumination 21 can be set for each of the associated operator without illumination 22. In this configuration, even if a plurality of operators without illumination 22 are associated with the operator with illumination 21, the user can easily identify which operator without illumination 22 was played.

The change in the lighting mode of each of the plurality of operators with illumination 21 can differ depending on the striking strength on the operator with illumination 21 or on the operator without illumination 22 associated with the operator with illumination 21. In this case, the user can visually check the lighting mode of the operator with illumination 21 to easily recognize the striking strength of the performance operation.

The change in the lighting mode of each of the plurality of operators with illumination 21 can differ depending on the depressing strength on the operator with illumination 21 or on the operator without illumination 22 associated with the operator with illumination 21. In this case, the user can visually check the lighting mode of the operator with illumination 21 to easily recognize the depressing strength of the performance operation.

The lighting mode of each of the plurality of operators with illumination 21 can differ depending on whether a striking performance operation or a depressing performance operation is carried out with respect to the operator with illumination 21 or the operator without illumination 22 associated with the operator with illumination 21. In this case, the user can visually check the lighting mode of the operator with illumination 21 to easily distinguish whether a striking performance operation was carried out or a depressing performance operation was carried out.

The lighting mode of the operation section with illumination 21A can change at a prescribed tempo even when the operation section with illumination 21A is not operated for performance. In this case, the user can visually check the lighting mode of the operation section with illumination 21A to recognize the tempo of the musical piece being played. In addition, it is possible to practice playing the musical piece in time with the tempo.

The tempo can be set by the user. In this case, the user can easily play the musical piece at the desired tempo.

The pattern of change of the lighting mode of the operation section with illumination 21A can change every prescribed number of bars. In this case, the user can visually check the lighting mode of the operation section with illumination 21A to easily recognize changes in the bars.

The pattern of change of the lighting mode of the operation section with illumination 21A can be selected by the user. In this case, the user can change the lighting mode of the operation section with illumination 21A in a desired pattern.

The lighting mode of the operation section with illumination 21A can be changed when the timing of a beat change coincides with the timing of a performance operation on the operation section with illumination 21A or the operation section without illumination 22A. In this case, the user can visually check the lighting mode of the operation section with illumination 21A to easily recognize whether the musical piece is being played in time with the tempo.

The operation section with illumination 21A and the operation section without illumination 22A can be provided on the same face. In this case, the user can easily combine the operation section with illumination 21A and the operation section without illumination 22A to carry out performance operations.

The performance input device 1 can have one end face facing the user, and the operation section with illumination 21A can be disposed at a location farther from the one end face than the operation section without illumination 22A. In this case, it is possible to prevent the user's hand or arm from obscuring the operation section with illumination 21A when the user operates the operation section without illumination 22A for performance. As a result, the user can easily see the lighting mode of the operation section with illumination 21A.

The performance input device 1 can further comprise a sound generation instruction unit 152 that outputs a sound generation instruction signal for instructing generation of sound corresponding to the operation section with illumination 21A or the operation section without illumination 22B that has been operated for performance, in response to the operation section with illumination 21A or the operation section without illumination 22B being operated for performance. In this case, the user can play by operating the operation section with illumination 21A or the operation section without illumination 22A for performance.

### 8. Other embodiments

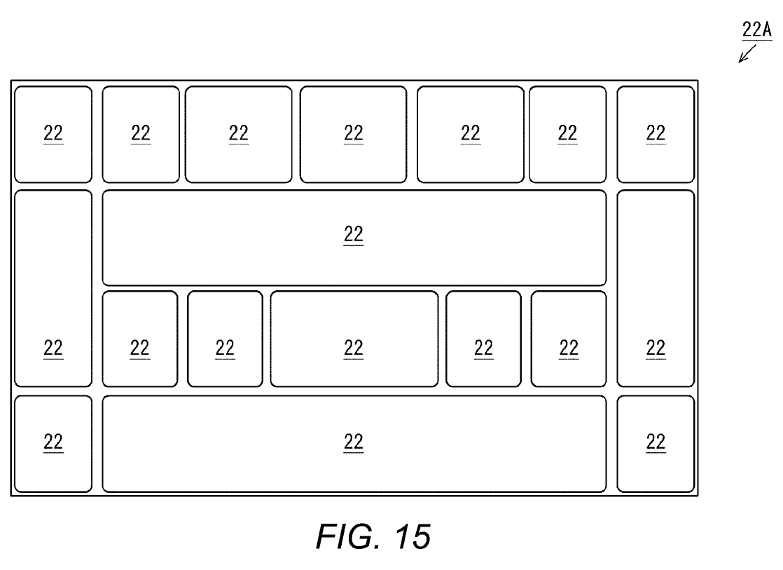

(1) In the embodiment described above, the plurality of operators without illumination 22 have mutually different shapes, but the embodiment is not limited thereto. The plurality of operators without illumination 22 can have the same shape. FIG. 15 is a plan view showing the operation section without illumination 22A according to another embodiment. As shown in FIG. 15, in the present embodiment, each of the operators without illumination 22 has an essentially rectangular shape in plan view. In addition, some of the operators without illumination 22 have the same shape.

(2) In the embodiment described above, the performance input device 1 is provided with the first to sixth additional function modes, but the embodiment is not limited thereto. At least some of the first to sixth additional function mode can be omitted from the performance input device 1.

(3) In the embodiment described above, the performance input device 1 is a finger drum pad, but the embodiment is not limited thereto. Any sampling sound can be associated with the performance operators 20. Accordingly, the performance input device 1 can be another electronic instrument, such as an electronic keyboard instrument. In this case, timbres of an acoustic piano, or the like, are associated with the plurality of performance operators 20.

(4) In the embodiment described above, the performance input device 1 includes the sound source unit 60 and the sound system 70, but the embodiment is not limited thereto. If an external sound system is connected to the communication I/F 120 and it is possible to output a sound signal to the external sound system from the sound source unit 60 via the communication I/F 120, the performance input device 1 does not need to include the sound system 70. In addition, if an external sound source unit is connected to the communication I/F 120 and it is possible to output a sound generation instruction signal to the external sound source unit, the performance input device 1 does not need to include the sound source unit 60.

In addition, the sound generation instruction signal can be used for purposes other than instructing the generation of sound. The sound generation instruction signal can be used to instruct muting of a sound that is being generated, an instruction to change the volume of a sound that is being generated, or an instruction to repeatedly generate a sound that is allocated to the performance operators 20 at a prescribed interval in time with the tempo. Alternatively, the sound generation instruction signal can be used to issue an instruction to convert a striking performance operation or a depressing performance operation to a control change (for example a MIDI (Musical Instrument Digital Interface) message) and to output the control change.

(5) In the embodiment described above, the performance operators 20 are provided on the main face 11 of the housing 10, but the embodiment is not limited thereto. The performance operators 20 can be provided on a main face different from the main face 11 of the housing 10. In addition, the operation section with illumination 21A and the operation section without illumination 22A can be provided on mutually different main faces of the housing 10. Accordingly, the operation section with illumination 21A and the operation section without illumination 22A does not need to be arranged along the depth direction, and the operation section with illumination 21A does not need to be disposed at a location farther from the main face 13 than the operation section without illumination 22A.

(6) In the embodiment described above, each of the operators without illumination 22 is associated with the operator 21 overlapping with the operator without illumination 22 in the depth direction, but the embodiment is not limited thereto. Each of the operators without illumination 22 can be associated with an operator with illumination 21 different from the operator 21 overlapping with the operator without illumination 22 in the depth direction. In addition, the correspondence between the operators without illumination 22 and the operators with illumination 21 can be set by the user via the setting operation unit 30. In this case, the user can associate each of the operators with illumination 21 with a desired operator without illumination 22. As a result, the user can easily recognize the correspondence between the operators with illumination 21 and the operators without illumination 22.

### 9. Summary of the embodiments

(Item 1) A performance input device according to item 1 comprises

an operation section with illumination that is configured to be illuminable and that is operated for performance, and

an operation section without illumination that is operated for performance, wherein

when the operation section with illumination is operated for performance, the lighting mode of the operation section with illumination changes.

In this performance input device, when the operation section with illumination is operated for performance, the lighting mode changes, thereby improving the aesthetics of the performance input device. In addition, since lighting is not provided in the operation section without illumination, the operational feel the operation section without illumination is not diminished, thus maintaining playability. As a result of the operation section with illumination and the operation section without illumination being appropriately provided, it is possible to maintain playability while improving the aesthetics of the performance input device.

(Item 2) In the performance input device described in item 1,

the operation section with illumination includes a plurality of operators with illumination,

the operation section without illumination includes a plurality of operators without illumination,

each of the plurality of operators with illumination is associated with one of the plurality of operators without illumination, and

the lighting mode of each of the plurality of operators with illumination can change when the operator with illumination is operated for performance, or when an operator without illumination associated with the operator with illumination is operated for performance.

In this configuration, the lighting mode of the operation section with illumination changes even when the operation section without illumination is operated for performance. As a result, the user can visually recognize that the operation section without illumination has been operated without diminishing the operational feel of the operation section without illumination. It is thereby possible to further improve playability.

(Item 3) In the performance input device described in item 2,

the operation section with illumination and the operation section without illumination are arranged along a first direction,

the plurality of operators with illumination are arranged along a second direction intersecting the first direction,

the plurality of operators without illumination are arranged along the second direction, and

each of the plurality of operators with illumination can be associated with an operator without illumination that overlaps in the first direction.

In this case, the operator with illumination is associated with the operator without illumination that is adjacent in the first direction. As a result, the user can instinctively recognize the correspondence between the operators with illumination and the operators without illumination.

(Item 4) In the performance input device described in item 2,

the correspondence between the plurality of operators without illumination and the plurality of operators with illumination can be set by a user.

In this case, the user can associate each of the operators with illumination with a desired operator without illumination. As a result, the user can easily recognize the correspondence between the operators with illumination and the operators without illumination.

(Item 5) In the performance input device described in any one of items 2 to 4,

the lighting mode of each of the plurality of operators with illumination can be set for each of the associated operator without illumination.

In this configuration, even if a plurality of operators without illumination are associated with an operator with illumination, the user can easily identify which operator without illumination was played.

(Item 6) In the performance input device described in any one of items 2 to 5,

the change in the lighting mode of each of the plurality of operators with illumination can differ depending on the striking strength (e.g., Note On Velocity) on the operator with illumination or on the operator without illumination associated with the operator with illumination.

In this case, the user can visually check the lighting mode of the operator with illumination to easily recognize the striking strength of the performance operation.

(Item 7) In the performance input device described in any one of items 2 to 6,

the change in the lighting mode of each of the plurality of operators with illumination can differ depending on the depressing strength (e.g., After Touch Value) on the operator with illumination or on the operator without illumination associated with the operator with illumination.

In this case, the user can visually check the lighting mode of the operator with illumination to easily recognize the depressing strength of the performance operation.

(Item 8) In the performance input device described in any one of items 2 to 7,

the lighting mode of each of the plurality of operators with illumination can differ depending on whether a striking performance operation or a depressing performance operation is carried out with respect to the operator with illumination or on the operator without illumination associated with the operator with illumination.

In this case, the user can visually check the lighting mode of the operator with illumination to easily distinguish whether a striking performance operation was carried out or a depressing performance operation was carried out.

(Item 9) In the performance input device described in any one of items 1 to 8,

the lighting mode of the operation section with illumination can change at a prescribed tempo even when the operation section with illumination is not operated for performance.

In this case, the user can visually check the lighting mode of the operation section with illumination to recognize the tempo of the musical piece being played. In addition, it is possible to practice playing the musical piece in time with the tempo.

(Item 10) In the performance input device described in item 9,

the tempo can be set by the user.

In this case, the user can easily play the musical piece at the desired tempo.

(Item 11) In the performance input device described in item 9 or 10,

the pattern of change of the lighting mode of the operation section with illumination can change every prescribed number of bars.

In this case, the user can visually check the lighting mode of the operation section with illumination to easily recognize changes in the bars.

(Item 12) In the performance input device described in any one of items 9 to 11,

the pattern of change of the lighting mode of the operation section with illumination can be selected by the user.

In this case, the user can change the lighting mode of the operation section with illumination in a desired pattern.

(Item 13) In the performance input device described in any one of items 9 to 12,

the lighting mode of the operation section with illumination can be changed when the timing of a beat change coincides with the timing of a performance operation on the operation section with illumination or the operation section without illumination.

In this case, the user can visually check the lighting mode of the operation section with illumination to easily recognize whether the musical piece is being played in time with the tempo.

(Item 14) In the performance input device described in any one of items 1 to 13,

the operation section with illumination and the operation section without illumination can be provided on the same face.

In this case, the user can easily combine the operation section with illumination and the operation section without illumination to carry out performance operations.

(Item 15) The performance input device described in any one of items 1 to 14 can further comprises

a one end surface facing a user, wherein

the operation section with illumination is disposed at a location farther from the one end face than the operation section without illumination.

In this case, it is possible to prevent the user's hand or arm from obscuring the operation section with illumination when the user operates the operation section without illumination for performance. As a result, the user can easily see the lighting mode of the operation section with illumination.

(Item 16) The performance input device described in any one of items 1 to 15 can further comprise

a sound generation instruction unit that outputs a sound generation instruction signal for instructing generation of sound corresponding to the operation section with illumination or the operation section without illumination that has been operated for performance, in response to the operation section with illumination or the operation section without illumination being operated for performance.

In this case, the user can play by operating the operation section with illumination or the operation section without illumination for performance.

(Item 17) A performance input method according to item 17 comprises

receiving a performance operation from an operation section with illumination of a performance input device,

receiving a performance operation from an operation section without illumination of the performance input device, and

changing the lighting mode of the operation section with illumination when the operation section with illumination is operated for performance,

wherein the method is executed by a computer.

According to this performance input method, as a result of the operation section with illumination and the operation section without illumination being appropriately provided, it is possible to maintain playability while improving the aesthetics of the performance input device.

What is claimed is:

1. A performance input device comprising:
an operation section with illumination configured to be illuminable and configured to be operated for performance; and
an operation section without illumination configured to be operated for performance,
in response to the operation section with illumination being operated for performance, lighting mode of the operation section with illumination changing.

2. The performance input device according to claim 1, wherein
the operation section with illumination includes a plurality of operators with illumination,
the operation section without illumination includes a plurality of operators without illumination,
at least one of the plurality of operators with illumination is associated with at least one of the plurality of operators without illumination, and
lighting mode of each of the at least one of the plurality of operators with illumination changes in response to a respective operator with illumination being operated for performance, or in response to an operator without illumination associated with the respective operator with illumination being operated for performance.

3. The performance input device according to claim 2, wherein
the operation section with illumination and the operation section without illumination are arranged along a first direction,
the plurality of operators with illumination are arranged along a second direction intersecting the first direction,
the plurality of operators without illumination are arranged along the second direction, and
each of the plurality of operators with illumination is associated with an operator without illumination that overlaps in the first direction.

4. The performance input device according to claim 2, wherein
correspondence between the plurality of operators without illumination and the plurality of operators with illumination is set by a user.

5. The performance input device according to claim 2, wherein
the lighting mode of each of the plurality of operators with illumination is set for each associated operator without illumination.

6. The performance input device according to claim 2, wherein
change in the lighting mode of each of the plurality of operators with illumination is different depending on striking strength on the operator with illumination or on an operator without illumination associated with the operator with illumination.

7. The performance input device according to claim 2, wherein
change in the lighting mode of each of the plurality of operators with illumination is different depending on depressing strength on the operator with illumination or on an operator without illumination associated with the operator with illumination.

8. The performance input device according to claim 2, wherein
the lighting mode of each of the plurality of operators with illumination is different depending on whether a striking performance operation or a depressing performance operation is carried out with respect to the operator with illumination or an operator without illumination associated with the operator with illumination.

9. The performance input device according to claim 1, wherein
the lighting mode of the operation section with illumination changes at a prescribed tempo while the operation section with illumination is not being operated for performance.

10. The performance input device according to claim 9, wherein
the tempo is set by a user.

11. The performance input device according to claim 9, wherein
a pattern of change of the lighting mode of the operation section with illumination changes every prescribed number of bars.

12. The performance input device according to claim 9, wherein
a pattern of change of the lighting mode of the operation section with illumination is selected by a user.

13. The performance input device according to claim 9, wherein
the lighting mode of the operation section with illumination changes in response to a timing of a beat change coinciding with a timing of a performance operation on the operation section with illumination or the operation section without illumination.

14. The performance input device according to claim 1, wherein
the operation section with illumination and the operation section without illumination are provided on a same face.

15. The performance input device according to claim 1, further comprising
an end face configured to face a user,
the operation section with illumination is disposed at a location farther from the end face than the operation section without illumination.

16. The performance input device according to claim 1, further comprising
a sound generation instruction unit configured to output a sound generation instruction signal for instructing generation of sound corresponding to the operation section with illumination or the operation section without illumination that has been operated for performance, in response to the operation section with illumination or the operation section without illumination being operated for performance.

17. The performance input device according to claim 1, further comprising
an electronic controller configured to change the lighting mode of the operation section with illumination in response to determining that the operation section with illumination is operated for performance.

18. A performance input method executed by a computer, the performance input method comprising:
receiving a performance operation from an operation section with illumination of a performance input device;
receiving a performance operation from an operation section without illumination of the performance input device; and
changing lighting mode of the operation section with illumination in response to receiving the performance operation from the operation section with illumination.
